(19) United States
(12) Patent Application Publication
(10) Pub. No.: US 2024/0277025 A1
(43) Pub. Date: Aug. 22, 2024

(54) Generation and Collection of Multiple Substrates for Aerosol Generation

(71) Applicant: JT International SA, Geneva (CH)

(72) Inventors: Alec Wright, Guildford (GB); Andrew Robert John Rogan, Forres Moray (GB)

(73) Assignee: JT International SA, Geneva (CH)

(21) Appl. No.: 18/569,873

(22) PCT Filed: Jun. 21, 2022
(86) PCT No.: PCT/EP2022/066890

§ 371 Date: Dec. 13, 2023

(30) Foreign Application Priority Data
Jun. 23, 2021 (EP) 21181176.5

(51) Int. Cl. A24C 5/01; B26D 7/18; B26D 7/32

(52) U.S. Cl. CPC A24C 5/01; B26D 7/1854; B26D 7/32; B26D 2007/322

(57) ABSTRACT

A method allows for serially forming a plurality of substrates for aerosol generation, and includes the steps of:
feeding (110) a continuous web of substrate material,
cutting out (120) the continuous web to define a plurality of substrates by rotating a cutting wheel having multiple cutting dies arranged circumferentially,
conveying (130) the defined substrates by a conveyor, and
lifting (140) the defined substrates from the conveyor by rotating a suction wheel having multiple suction areas arranged circumferentially.

### FIELD OF THE INVENTION

The present invention relates to the generation of substrates intended for being used in aerosol generation devices to generate aerosol.

### BACKGROUND

Some aerosol generation devices, generally called “T-vapor (or heat-not-burn (or “HnB”)) devices”, comprise an aerosol generation unit arranged for receiving a consumable comprising a solid substrate (for instance a tobacco stick) with a possible filter and generally wrapped in a paper, into a heating chamber, and for transforming this substrate into an aerosol that may be inhaled by a user through successive draws (or puffs or else inhalation phases).

When this type of aerosol generation device is portable, i.e. usable when held by a user, it further comprises a battery (or power source) possibly rechargeable and storing electrical energy that is used by the aerosol generation unit for generating the aerosol. In this case the aerosol generation device may be a vaporizer or an electronic cigarette.

In the following description the term “substrate” is used to designate any solid aerosol-forming substance that is aerosolizable in air to form an aerosol. The substrate may comprise one or more of nicotine, cannabinoid, tobacco material, polyol, caffeine or other active components. An active component may be carried by a carrier which may include propylene glycol or glycerin, for instance. A flavoring may also be present in the substrate. This flavoring may include Ethylvanillin (vanilla), menthol, Isoamyl acetate (banana oil) or similar, for instance.

Moreover, in the following description the term “aerosol” may include a suspension of substance as one or more of solid particles, liquid droplets and gas. Such a suspension may be in a gas including air. Aerosol herein may generally refer to, or include, a vapor, and may include one or more components of the substrate.

It has been proposed, notably in the patent document WO-A1 2019/129493, to produce (or generate) a continuous cylindrical web of substrate material with multiple components, which is later on cutted out manually to define a plurality of cylindrical substrates. Actually, there is not an appropriate industrial process allowing for generating substrates without any manual intervention and with low dimensional variations, and possibly in parallel, notably when the substrates are very thin, such as the one having a flat plate shape.

Therefore, an object of this invention is to improve the situation, and notably to allow industrial generation of substrates with low dimensional variations.

### SUMMARY OF THE INVENTION

The proposed invention provides notably an embodiment of a method intended for serially forming a plurality of substrates for aerosol generation, and comprising the steps of:
feeding a continuous web of substrate material,
cutting out the continuous web to define a plurality of substrates by rotating a cutting wheel having multiple cutting dies arranged circumferentially, and
conveying the defined substrates by means of a conveyor.

This method is characterized in that it further comprises a step of lifting the defined substrates from the conveyor by rotating a suction wheel having multiple suction areas arranged circumferentially.

Thanks to the invention an industrial generation and collection of substrates having a constant shape and a constant weight is now possible without any manual intervention, even with a flat plate shape.

The embodiment of method may comprise other aspects or features, considered separately or combined, as defined hereafter:
the conveyor may be a substantially planar conveyor, i.e., a conveyor having a substantially planar surface; for example the conveyor may be a conveyor belt and may be an endless belt conveyor;
the lifting step may comprise synchronizing the suction wheel with the cutting wheel by mechanically connecting or electronically indexing the suction wheel with the cutting wheel;
the lifting step may be carried out by means of a suction wheel comprising as many suction areas as cutting dies on the cutting wheel;
the lifting step may be carried out by means of a suction wheel comprising suction areas each configured to generate a reduced pressure to suction a defined substrate on the conveyor;
the lifting step may further comprise releasing the suction in a suction area retaining a defined substrate when this suction area reaches a collection zone, in order that this defined substrate is collected in this collection zone;
the cutting out step may comprise a sub-step of removing each defined substrate from each cutting die;
the removing sub-step may comprise pushing out each defined substrate from its cutting die by releasing a biasing force stored by a shoe of this cutting die, in contact with this defined substrate, during the cutting out. In a variant of embodiment, the removing sub-step may comprise pushing out each defined substrate from its cutting die by means of a pressurized gas acting on this defined substrate from the inside of this cutting die;
in the cutting out step N substrates, with N≥2, may be simultaneously defined in parallel in the continuous web by N cutting dies belonging to N successive sub-parts of the cutting wheel set perpendicular to a rotation axis of the cutting wheel. In this case, in the lifting step N substrates may be simultaneously lifted in parallel by N parallel suction areas belonging to N successive sub-parts of the suction wheel set perpendicular to a rotation axis of the suction wheel;
· the cutting out step may define substrates having a flat plate shape;
the feeding step and the conveying step may use a same conveyor;
the method may further comprise a step of forming the continuous web by means of an extruder.

The proposed invention provides also an embodiment of an installation intended for serially forming a plurality of substrates for aerosol generation, and comprising a feeding means arranged for feeding a continuous web of substrate material, a rotating cutting wheel having multiple cutting dies arranged circumferentially and for cutting out this continuous web to define a plurality of substrates, and a conveyor arranged for conveying the defined substrates.

This installation is characterized in that it further comprises a rotating suction wheel having multiple suction areas arranged circumferentially and for lifting the defined substrates from the conveyor.

### BRIEF DESCRIPTION OF THE FIGURES

The invention and its advantages will be better understood upon reading the following detailed description, which is given solely by way of non-limiting examples and which is made with reference to the appended drawings, in which:

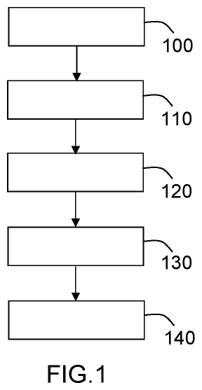

the FIG. 1 (FIG. 1) schematically illustrates an example of an algorithm implementing a method according to the invention,

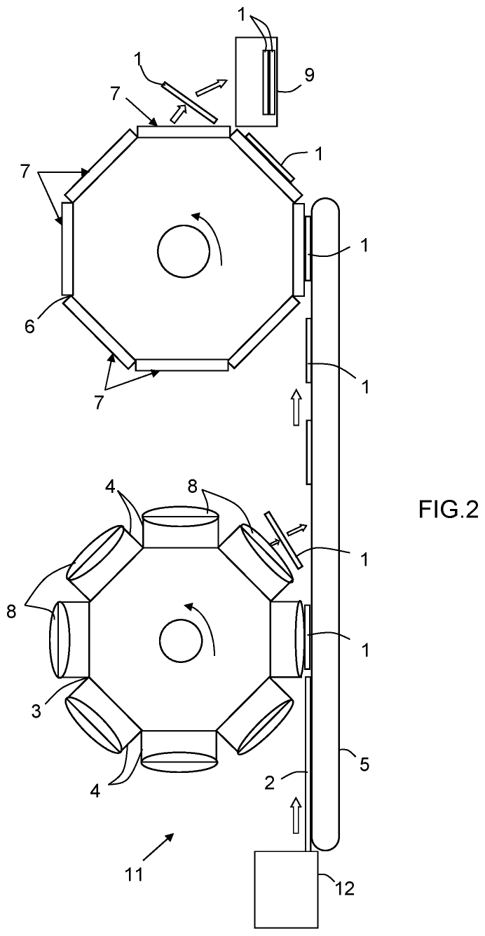

the FIG. 2 (FIG. 2) schematically and functionally illustrates, in a side view, an example of embodiment of an installation implementing the method according to the invention, and

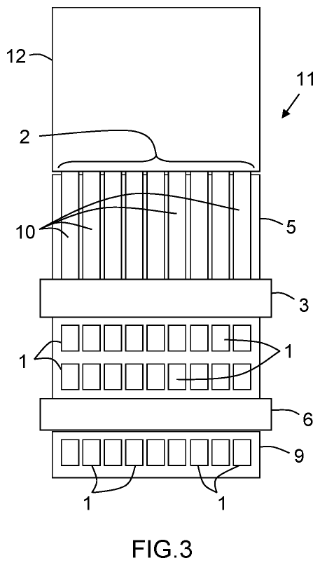

the FIG. 3 (FIG. 3) schematically and functionally illustrates, in a top view, the installation of FIG. 2.

### DETAILED DESCRIPTION OF EMBODIMENTS

The invention aims, notably, at offering a method, and an associated installation 11, intended for serially forming (or generating) substrates 1 with low dimensional variations from a continuous web 2 of solid substrate material, these substrates 1 being intended for being used in aerosol generation devices to generate aerosol.

In the following description it will be considered that the generated solid substrates 1 are intended to be part of consumables in which they are wrapped in a paper, possibly with a filter. But this is not mandatory because a solid substrate 1 could be used alone in the heating chamber of an aerosol generation device.

Moreover, in the following description it will be considered that the solid substrates 1, and therefore the consumables they belong to, have a flat plate shape. But this is not mandatory.

More, in the following description it will be considered that the aerosol generation devices are (or constitute) T-vapor (or heat-not-burn (or HnB)) devices. But the aerosol generation devices could be of another type, as soon as they are arranged for transforming a solid substrate (or aerosol-forming substance) mixed with air into an aerosol (possibly close to room temperature) that may be inhaled by a user through successive puffs (or draws or inhalation phases) during a vaping session.

It is recalled that a T-vapor device comprises an aerosol generation unit comprising a dedicated cavity intended for receiving a consumable containing a substrate 1 and that may be a heating chamber. The consumable may be manually replaced by the user when there is no more substrate in it. The dedicated cavity communicates with an outlet of an air flow channel to be supplied with air originating from at least one inlet of this air flow channel. The substrate 1 is arranged for generating an aerosol when it is heated (without burning) and mixed with air. This heating is performed by a heater supplied with electrical energy, originating from a power source (possibly a rechargeable battery), and belonging to the aerosol generation unit. For instance, this heater may be positioned adjacent to, or around the heating chamber and therefore the consumable. Also for instance, this heater may be a flat ceramic heater forming a part of the inner surface of the heating chamber to directly heat the substrate, or a thin film heater wrapped around the outer surface of the heating chamber to heat its side walls and at least a part of its internal volume. Also for instance, the heater may heat the substrate 1 to a temperature comprised between 150° C. and 350° C. The aerosol generated in the heating chamber is inhaled by the user of the aerosol generation device through an outlet, which may belong to the dedicated cavity or to a mouthpiece coupled to the latter.

It is also recalled that the term “substrate” is used to designate any solid aerosol-forming substance that is aerosolizable in air to form an aerosol. The substrate may comprise one or more of nicotine, cannabinoid, tobacco material, polyol, caffeine or other active components. An active component may be carried by a carrier which may include propylene glycol or glycerin, for instance. A flavoring may also be present in the substrate. This flavoring may include Ethylvanillin (vanilla), menthol, Isoamyl acetate (banana oil) or similar, for instance.

It is also recalled that the term “aerosol” may include a suspension of substance as one or more of solid (very small) particles, liquid droplets and gas, and that such a suspension may be in a gas including air.

A non-limiting example of an algorithm implementing a method 100-140 according to the invention is illustrated in FIG. 1. As illustrated, a method 100-140, according to the invention, comprises at least four steps 110 to 140 and may be implemented, for instance, by means of an installation 11 such as the one illustrated in the non-limiting example of FIGS. 2 and 3.

This installation 11 comprises at least a cutting wheel 3 having multiple cutting dies 4 arranged circumferentially, a conveyor 5, and a suction wheel 6 having multiple suction areas 7 arranged circumferentially.

A feeding step 110 of the method is intended for feeding a continuous web 2 of substrate material.

A cutting out step 120 of the method is intended for cutting out this continuous web 2 to define a plurality of substrates 1 by rotating the cutting wheel 3. In this cutting out step 120 the substrates 1 are serially defined by the multiple cutting dies 4 of the cutting wheel 3 (arranged circumferentially).

A conveying step 130 of the method is intended for conveying the defined substrates 1 to the suction wheel 6 by means of the conveyor 5. The conveyor 5 is a substantially planar conveyor 5 and, thus, has a substantially planar surface. In the illustrated example, the conveyor 5 is a conveyor belt, and specifically an endless belt conveyor.

A lifting step 140 of the method is intended for lifting the defined substrates 1 from the conveyor 5 by rotating the suction wheel 6. In this lifting step 140 the substrates 1 are serially lifted in the multiple suction areas 7 of the suction wheel 6 (arranged circumferentially).

So, the installation 11 provides a continuous web 2 that is cut by the multiple cutting dies 4 of the rotating cutting wheel 3 to define (or form) serially multiple substrates 1 that are conveyed by the conveyor 5 to the rotating suction wheel 6 where they are serially lifted in the multiple suction areas 7.

This allows an industrial generation and collection of substrates 1 having a constant shape and a constant weight without any manual intervention, even with the flat plate shape. Moreover, this allows a cost reduction of the consumables and a possible reduction in dimensions of the heating chamber of the aerosol generation unit (and then possibly of the aerosol generation device) because of the reduced dimensional variations.

In a first embodiment the lifting step 140 may comprise synchronizing the suction wheel 6 with the cutting wheel 3 by mechanically connecting the suction wheel 6 with the cutting wheel 3. In a second embodiment, the lifting step 140 may comprise synchronizing the suction wheel 6 with the cutting wheel 3 by electronically indexing the suction wheel 6 with the cutting wheel 3. This allows to optimize the serial production of substrates 1.

For instance, the lifting step 140 may be carried out by means of a suction wheel 6 comprising as many suction areas 7 as cutting dies 4 on the cutting wheel 3. So, when the suction wheel 6 drops the substrates 1 they are evenly spaced, which allows to optimize the serial production of substrates 1.

Also for instance, the lifting step 140 may be carried out by means of a suction wheel 6 comprising suction areas 7 each configured to generate a reduced pressure to suction a defined substrate 1 on the conveyor 5. To this effect, the installation 11 may comprise a suction circuit coupled to the internal part of the suction wheel 6 in each suction area 7 to allow suction of a substrate 1 through holes defined in each suction area 7 when the latter (7) comes into contact with this substrate 1. Using a vacuum to change the pressure and hold the defined substrate 1 is an interesting embodiment because it is much faster than mechanically holding the defined substrate 1 and does not deform the shape of the defined substrate 1.

It should be noticed that the lifting step 140 may further comprise releasing the suction in a suction area 7 retaining a defined substrate 1 when this suction area 7 reaches a collection zone 9. This allows each defined substrate 1 to be collected in the collection zone 9. As illustrated in the non-limiting example of FIGS. 2 and 3, the collection zone 9 may be an open box (or container) located at the end of the conveyor 5 just below the place where each substrate 1 leaves its suction area 7 when the suction is released in it. But in a variant the collection zone 9 could be another conveyor belt.

It should also be noticed that the cutting out step 120 may comprise a removing sub-step during which each defined substrate 1 is removed from each corresponding cutting die 4. Indeed, when a cutting die 4 cuts out a substrate 1 from the continuous web 2, this substrate 1 may stick to the corresponding cutting die 4 and therefore needs to be removed in order to not introduce any perturbation in the serial substrate generation.

For this purpose, at least two embodiments can be envisioned.

A first embodiment requires that the end of each cutting die 4 comprises a shoe 8 that comes in contact with a substrate 1 during the cut-out and stores a biasing force during this contact, as illustrated in the non-limiting example of FIG. 2. In this first embodiment the removing sub-step comprises pushing out each defined substrate 1 from its cutting die 4 by releasing the biasing force stored by the corresponding shoe 8 of this cutting die 4. So, when a shoe 8 with a stored biasing force comes into contact with a part of the continuous web 2 during the cut-out and this part sticks to this shoe 8, the releasing of the stored biasing force allows this part (after having been fully cut out) to be removed from this shoe 8 and therefore to fall on the conveyor 5 at a predefined location. This biasing force may be produced by means of a spring with a cam driven clip to hold it in place or by means of a pneumatic actuator.

A second embodiment requires that the cutting wheel 3 comprises a pressurized gas circuit coupled to the internal part of each cutting die 4 to allow a pulse of pressurized gas to cross through holes defined in the end of each cutting die 4 at predefined times. In this second embodiment the removing sub-step comprises pushing out each defined substrate 1 from its cutting die 4 by means of a pulse of pressurized gas acting on the defined substrate 1 from the inside of this cutting die 4. So, when the end of a cutting die 4 comes into contact with a part of the continuous web 2 during the cut-out and this part sticks to this shoe 8, a pulse of pressurized gas is supplied to the holes of this cutting die end which allows this part (after having been fully cut out) to be removed from this cutting die end and therefore to fall on the conveyor 5 at a predefined location.

It should also be noticed, as illustrated in the non-limiting example of FIG. 3, that during the cutting out step 120 N substrates 1, with N≥2, may be simultaneously defined in parallel in the continuous web 2 by N cutting dies 4 belonging to N successive sub-parts of the cutting wheel 3 set perpendicular to the rotation axis of the cutting wheel 3. In this embodiment, in the lifting step 140 N substrates 1 may be simultaneously lifted in parallel by N parallel suction areas 7 belonging to N successive sub-parts of the suction wheel 6 set perpendicular to the rotation axis of the suction wheel 6. Such an option allows to increase considerably the number of substrates 1 that are generated by the installation 11 per minute. The precise and simultaneous cut-out in parallel of N parts of the continuous web 2 is facilitated when the latter (2) is divided in advance into N parallel strips 10 as illustrated in the non-limiting example of FIG. 3.

In the non-limiting example illustrated in FIG. 3 N=9, but N may take any value greater or equal to 2.

It should also be noticed, as illustrated in the non-limiting example of FIGS. 2 and 3, that the feeding step 110 and the conveying step 130 may use the same conveyor 5 of the installation 11. In this case the conveyor 5 acts as a feeding means in the installation 11. This allows to simplify the latter (11) but also to confer a compact design to the installation 11.

It should also be noticed, as illustrated in the non-limiting example of the algorithm of FIG. 1, that the method may further comprise a forming step 100 in which the continuous web 2 is formed by means of an extruder 12. In this case, the continuous web 2, delivered by the output of the extruder 12, may fall on the conveyor 5 upstream of the cutting wheel 3, which allows cutting out substrates 1 online directly after extrusion without requiring a second offline installation. It should also be noticed, as illustrated in the non-limiting example of FIG. 3, that the extruder 12 may allow to generate directly the N parallel strips 10 of the continuous web 2.

In an exemplary and non-limiting example, each substrate 1 generated by the installation 11 may have a flat plate shape. In this case each generated substrate 1 may have a length (in the longitudinal direction) of approximately 18.0 mm, a width of approximately 11.8 mm, and a thickness (or depth) of approximately 1.2 mm. The consumable comprising such a substrate 1 may have a width of approximately 12.0 mm and a thickness (or depth) of approximately 1.4 mm to accommodate this substrate 1 inside a wrapping member (or paper).

It should be appreciated by those skilled in the art that some block diagrams of FIGS. 2 and 3 herein represent conceptual views of illustrative elements and circuitry embodying the principles of the invention. The description and drawing merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

1. A method for serially forming a plurality of substrates for aerosol generation, said method comprising the steps of:
feeding a continuous web of substrate material,
cutting out said continuous web to define a plurality of substrates by rotating a cutting wheel having multiple cutting dies arranged circumferentially,
conveying said defined substrates by a conveyor, and
lifting said defined substrates from said conveyor by rotating a suction wheel having multiple suction areas arranged circumferentially.

2. The method according to claim 1, wherein said lifting step comprises synchronizing said suction wheel with said cutting wheel by mechanically connecting said suction wheel with said cutting wheel.

3. The method according to claim 1, wherein said lifting step comprises synchronizing said suction wheel with said cutting wheel by electronically indexing said suction wheel with said cutting wheel.

4. The method according to claim 1, wherein said lifting step is carried out by the suction wheel comprising as many suction areas as cutting dies on said cutting wheel.

5. The method according to claim 1, wherein said lifting step is carried out by the suction wheel comprising suction areas each configured to generate a reduced pressure to suction a defined substrate on said conveyor.

6. The method according to claim 1, wherein said lifting step further comprises releasing the suction in one of the multiple suction areas retaining a corresponding one of the plurality of defined substrates when said one suction area reaches a collection zone, in order that said one defined substrate is collected in said collection zone.

7. The method according to claim 1, wherein said cutting out step comprises a sub-step of removing each of the plurality of defined substrates from each of the multiple cutting dies.

8. The method according to claim 7, wherein said removing sub-step comprises pushing out each of the plurality of defined substrates from the corresponding one of the multiple cutting dies by releasing a biasing force stored by a shoe of the one cutting die, in contact with said one of the defined substrates, during said cutting out.

9. The method according to claim 7, wherein said removing sub-step comprises pushing out each of the plurality of defined substrates from the corresponding one of the multiple cutting dies by a pressurized gas acting on said one defined substrate from an inside of said one cutting die.

10. The method according to claim 1, wherein in said cutting out step the plurality of defined substrates comprise N substrates, with N≥2, simultaneously defined in parallel in said continuous web by the multiple cutting dies comprising N cutting dies belonging to N successive sub-parts of said cutting wheel set perpendicular to a rotation axis of said cutting wheel, and in said lifting step the N substrates are simultaneously lifted in parallel by the multiple suction areas comprising N parallel suction areas belonging to N successive sub-parts of said suction wheel set perpendicular to a rotation axis of said suction wheel.

11. The method according to claim 1, wherein said cutting out step defines the plurality of substrates having a flat plate shape.

12. The method according to claim 1, wherein said feeding step and said conveying step use the same conveyor.

13. The method according to claim 1, wherein the method further comprises a step of forming said continuous web by an extruder.

14. An installation for serially forming a plurality of substrates for aerosol generation, said installation comprising:
a feeding means arranged for feeding a continuous web of substrate material,
a rotating cutting wheel having multiple cutting dies arranged circumferentially and for cutting out said continuous web to define a plurality of substrates,
a conveyor arranged for conveying said defined substrates, and
a rotating suction wheel having multiple suction areas arranged circumferentially and for lifting said defined substrates from said conveyor.
